(19) United States
(12) Patent Application Publication
(10) Pub. No.: US 2024/0114459 A1
(43) Pub. Date: Apr. 4, 2024

(54) METHOD FOR OPTIMIZING POWER CONSUMPTION IN A USER EQUIPMENT

(71) Applicant: Samsung Electronics Co., Ltd., Suwon-si (KR)

(72) Inventors: Anoop Perumudi VEEDU, Bangalore (IN); Vivek MURUGAIYAN, Bangalore (IN); Nishant ., Bangalore (IN); Kailash Kumar JHA, Bangalore (IN); Siddharth SHUKLA, Bangalore (IN)

(21) Appl. No.: 18/464,440

(22) Filed: Sep. 11, 2023

Related U.S. Application Data
(63) Continuation of application No. PCT/KR2023/013448, filed on Sep. 7, 2023.

(30) Foreign Application Priority Data
Sep. 29, 2022 (IN) 202241055959
Jul. 19, 2023 (IN) 2022 41055959

(51) Int. Cl. H04W 52/02; H04W 76/28

(52) U.S. Cl. CPC H04W 52/0248; H04W 52/0212; H04W 76/28; H04W 84/042

(57) ABSTRACT

The disclosure relates to a 5G or 6G communication system for supporting a higher data transmission rate. A method for optimizing power in a user equipment (UE) is provided. The method includes receiving, from a network, one or more relaxed measurement parameters, determining one of a mobility state or a location of the UE with respect to an edge of a serving cell of a visited public land mobile network (VPLMN) of the network based on one or more relaxed measurement parameters, and deferring a background PLMN (BPLMN) search upon determining one of the UE being in a low mobility state or not being at the edge of the serving cell, and/or deferring a near cell measurement search during a measurement gap of a connected mode discontinuous reception (CDRX) sleep duration of a CDRX state to optimize the power consumption in the UE upon determining one of the UE being in the low mobility state or not being located at the edge of the serving cell.

### CROSS-REFFERENCE TO RELATED APPLICATION(S)

This application is a continuation application, claiming priority under § 365(c), of an International application No. PCT/KR2023/013448, filed on Sep. 7, 2023, which is based on and claims the benefit of an Indian Provisional patent application number 202241055959, filed on Sep. 29, 2022 in the Indian Patent Office, and of an Indian Non-Provisional patent application number 202241055959, filed on Jul. 19, 2023, in the Indian Patent Office, the disclosure of each of which is incorporated by reference herein in its entirety.

### FIELD

The disclosure generally relates to the field of cellular networks. More particularly, the disclosure relates to a method for optimizing power consumption in a user equipment (UE).

### BACKGROUND

Fifth generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step physical random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is a method for optimizing power consumption in a user equipment (UE).

Additional aspects will be set forth in part in the description which follows and, in part, will be apparent from the description, or may be learned by practice of the presented embodiments.

In accordance with an aspect of the disclosure, a method performed by a UE in a communication system is provided. The method includes receiving, from a network, a message including one or more relaxed measurement parameters, determining at least one of a mobility state or a location of the UE with respect to an edge of a serving cell based on the one or more relaxed measurement parameters, and deferring a background PLMN (BPLMN) search based on determining at least one of the UE being in a low mobility state or not being at the edge of the serving cell to optimize a power in the UE.

In accordance with another aspect of the disclosure, a method performed by a UE in a communication system is provided. The method includes receiving, from a network, a message including one or more relaxed measurement parameters, determining at least one of the mobility state or the location of the UE with respect to the edge of the serving cell of the connected network based on the one or more relaxed measurement parameters, and deferring a near cell measurement search during a measurement gap of a connected mode discontinuous reception (CDRX) sleep duration of a CDRX state to optimize the power in the UE based on determining at least one of the UE being in the low mobility state or not being located at the edge of the serving cell.

In accordance with another aspect of the disclosure, a communication device is provided. The communication device includes a transceiver and a processor coupled with the transceiver and configured to receive, from the network, a message including one or more relaxed measurement parameters, determine at least one of the mobility state or the location of the UE with respect to an edge of the serving cell based on the one or more relaxed measurement parameters, and defer the BPLMN search based on determining at least one of the UE being in the low mobility state or not being at the edge of the serving cell to optimize the power in the UE.

In accordance with another aspect of the disclosure, a communication device is provided. The communication device includes a transceiver and a processor operably coupled with the transceiver and configured to receive, from a network, a message including one or more relaxed measurement parameters, determine at least one of the mobility state or the location of the UE with respect to the edge of the serving cell of the connected network based on the one or more relaxed measurement parameters, and defer the near cell measurement search during the measurement gap of a connected mode discontinuous reception (CDRX) sleep duration of a CDRX state to optimize the power in the UE based on determining at least one of the UE being in the low mobility state or not being located at the edge of the serving cell.

To further clarify the advantages and features of the disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings in which:

FIG. 1 illustrates a method for measuring relaxed radio resource management (RRM) measurement in a cellular network, according to the related art;

FIG. 2 is a flow diagram illustrating a method of the related art for home public land mobile network (HPLMN) scanning when a user equipment (UE) camped on a visited public land mobile network (VPLMN) of a cellular network according to the related art;

FIG. 3A illustrates a connected mode discontinuous reception (CDRX) feature, according to the related art;

FIG. 3B is a flow diagram illustrating a method of the related art for performing neighbour cell measurements with overlapping measurement gap(s) and CDRX sleep duration according to the related art;

FIG. 3C illustrates an overlapping scenario of measurement gap(s) and a CDRX sleep duration according to the related art;

FIG. 4A illustrates a graphical representation depicting a periodicity between two BPLMN scans with reference to relaxed measurement features according to the related art;

FIG. 4B illustrates a graphical representation depicting a periodicity between two BPLMN scans with reference to relaxed measurement features according to an embodiment of the disclosure;

FIG. 5A is a flow diagram illustrating a method for HPLMN scanning when a UE is camped on a VPLMN of a cellular network according to an embodiment of the disclosure;

FIG. 5B is a flow diagram illustrating a method for HPLMN scanning when a UE is camped on a VPLMN of a cellular network according to an embodiment of the disclosure;

FIG. 6A illustrates a graphical representation depicting a periodicity between two BPLMN scans with reference to relaxed measurement features according to the related art;

FIG. 6B illustrates a graphical representation depicting a periodicity between two BPLMN scans with reference to relaxed measurement features according to an embodiment of the disclosure;

FIG. 7A is a flow diagram illustrating a method for HPLMN scanning when a UE is camped on a VPLMN of a cellular network according to an embodiment of the disclosure;

FIG. 7B is a flow diagram illustrating a method for a HPLMN scanning when a UE is camped on a VPLMN of a cellular network according to an embodiment of the disclosure;

FIG. 8A illustrates a graphical representation depicting a periodicity between two BPLMN scans with reference to relaxed measurement features according to the related art;

FIG. 8B illustrates a graphical representation depicting a periodicity between two BPLMN scans with reference to relaxed measurement features according to an embodiment of the disclosure;

FIG. 9 is a flow diagram illustrating a method for performing neighbour cell measurements with overlapping measurement gap(s) and CDRX sleep duration according to an embodiment of the disclosure;

FIG. 10 illustrates a difference between a method and a method of the related art for performing neighbour cell measurements with overlapping measurement gap(s) and CDRX sleep duration according to an embodiment of the disclosure

FIG. 11 illustrates a block diagram of a UE for optimizing power consumption according to an embodiment of the disclosure;

FIG. 12 is a flow diagram illustrating a method for a HPLMN scanning when a UE is camped on a VPLMN of a cellular network according to an embodiment of the disclosure;

FIG. 13 is a flow diagram illustrating a method for performing neighbour cell measurements with overlapping measurement gap(s) and CDRX sleep duration according to an embodiment of the disclosure;

FIG. 14 illustrates various functionalities of an artificial intelligence (AI)/machine learning (ML) model associated with a UE for performing a higher priority scan optimization according to an embodiment of the disclosure;

FIG. 15A is a flow diagram illustrating a method for performing a higher priority scan optimization according to an embodiment of the disclosure; and

FIG. 15B is a flow diagram illustrating a method for performing a higher priority scan optimization according to an embodiment of the disclosure.

Throughout the drawings, it should be noted that like reference numbers are used to depict the same or similar elements, features, and structures.

### DETAILED DESCRIPTION OF FIGURES

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Reference throughout this specification to “an aspect”, “another aspect” or similar language means that a particular feature, structure, or characteristic described in connection with the embodiment is included in at least one embodiment of the disclosure. Thus, appearances of the phrase “in an embodiment”, “in one embodiment”, “in another embodiment”, and similar language throughout this specification may, but do not necessarily, all refer to the same embodiment.

The terms “comprise”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. In addition, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits, such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports, such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

Throughout this disclosure, the terms “network” and “cellular network” are used interchangeably and mean the same. Further, the terms “UE” and “communication device” are used interchangeably and mean the same.

Power saving is essential in a cellular network, especially for user equipment (UEs), such as smartphones, which have limited power sources. The third generation partnership project (3GPP) has defined a number of procedures and strategies for reducing power consumption in the UE. Despite the availability of numerous power optimization techniques, the UEs continue to seek improvements in power efficiency. Fifth generation (5G) new radio (NR) standard provides much superior low-energy functioning as compared to earlier standards (e.g., fourth generation (4G)). The 5G NR provides the low-energy functionalities mostly due to much improved power-saving capabilities in low-to-medium traffic. Various developments related to UE power-saving strategies are evolving by taking latency and performance into account. These developments have been described in the 3GPP technical report (TR) 38.840, which was released in Release-16. The UE power-saving strategies include lowering UE power consumption as a result of radio resource management (RRM) measurement(s). In addition, the UEs with low mobility do not require frequent RRM measurements in comparison to the UEs with high mobility. The UEs with low mobility may improve power consumption by avoiding unnecessary RRM measurement by getting information from a network.

The RRM measurement is one essential part of the power consumption that may continuously be performed by the UEs to gain or remain in service during the mobility. The RRM measurement may be performed in all states of the UEs. In Release-16, the 3GPP has introduced a feature called NR Relaxed measurement that helps save power by relaxing the RRM measurements during an idle or inactive state of the UEs, specifically for cell reselection. The UE may be allowed to relax its measurements when two criteria are met. A first criteria among the two criteria is “low mobility”, and a second criteria is “not at cell edge”. These criteria indicate that the UEs may be located in an area with a good signal, and there are no better neighbouring cells that the UEs can detect during the measurement because of their low mobility. NR relaxed measurement (e.g., RRM measurement) configuration is received through a system information block 2 (SIB2) from the network, which contains information about “lowMobilityEvaluation-r16” and “cellEdgeEvaluation-r16”. The NR relaxed measurement configuration also includes “highPriorityMeasRelax-r16”, which may relax mandatory measurement of high-priority inter-frequency signals during the idle or inactive state of the UEs, as shown in Table 1.

```
TABLE 1
System Information Block 2 (3GPP 38.331 v16.7.0)
relaxedMeasurement-r16 SEQUENCE {
    lowMobilityEvaluation-r16 SEQUENCE {
      s-SearchDeltaP-r16 ENUMERATED {
            dB3, dB6, dB9, dB12, dB15,
          spare3, spare2, spare1},
      t-SearchDeltaP-r16 ENUMERATED {
            s5, s10, s20, s30, s60, s120, s180,
          s240, s300, spare7, spare6, spare5,
          spare4, spare3, spare2, spare1}
      }
OPTIONAL,  -- Need R
    cellEdgeEvaluation-r16   SEQUENCE {
      s-SearchThresholdP-r16   ReselectionThreshold,
      s-SearchThresholdQ-r16  ReselectionThresholdQ
OPTIONAL  -- Need R
      }
OPTIONAL,  -- Need R
    combineRelaxedMeasCondition-r16 ENUMERATED {true}
        OPTIONAL,  -- Need R
    highPriorityMeasRelax-r16  ENUMERATED {true}
        OPTIONAL  -- Need R
  }
```

The above-mentioned parameters help to determine whether the UE is in a low mobility state or not at the cell edge, allowing the UE to skip performing RRM measurements for the neighbouring cells even if the normal cell reselection criteria(s) are met, as shown in Table 1 and Table 2.

TABLE 2
SIB2 relaxed measurement parameters

| | |
|---|---|
| lowMobilityEvaluation | Indicates the criteria for a UE to detect low |
| | mobility, in order to relax measurement |
| | requirements for cell reselection |
| highPriorityMeasRelax | Indicates whether measurements can be relaxed |
| | on high priority frequencies |
| cellEdgeEvaluation | Indicates the criteria for a UE to detect that it is |
| | not at the cell edge, in order to relax |
| | measurement requirements for cell reselection. |
| SSearchDeltaP | Specifies the threshold (in dB) on Srxlev variation |
| | for relaxed measurement |
| TsearchDeltaP | specifies the time period over which the Srxlev |
| | variation is evaluated for relaxed measurement |
| SsearchThresholdP | Specifies the Srxlev threshold (in dB) for relaxed |
| | measurement. |
| SsearchThresholdQ | Specifies the Squal threshold (in dB) for relaxed |
| | measurement |
| combineRelaxedMeas | When both lowMobilityEvalutation and |
| Condition | cellEdgeEvalutation criteria are present in SIB2, |
| | this parameter configures the UE to-13-ulfil |
| | both criteria in order to relax measurement |
| | requirements for cell reselection |

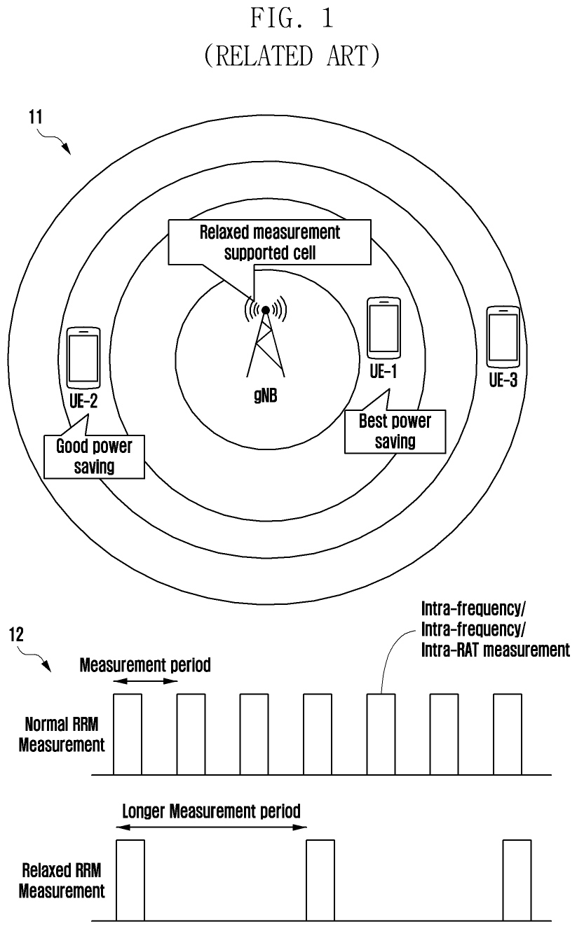

FIG. 1 illustrates a method for measuring relaxed radio resource management (RRM) measurement in a cellular network, according to the related art.

Referring to FIG. 1, by relaxing these RRM measurements, the UEs may save power while maintaining a desired mobility performance. An example scenario illustrating a method for measuring RRM measurement in the cellular network, according to the prior art. For example, as illustrated in FIG. 1, a scenario 11 where UE-1 and UE-2 receive a strong signal from a current cell (e.g., gNB), supports relaxed measurement. Additionally, the UE-1 and UE-2 receive the NR relaxed measurement configuration through the SIB2, which confirms that the UE-1 and UE-2 are in the low mobility state and not at the cell edge. Consequently, the UE-1 and UE-2 can skip unnecessary RRM measurements 12, conserving power and improving their overall mobility performance. However, the scenario 11 is different for another UE (i.e., UE-3), as UE-3 is in a high mobility state and at the cell edge. As a result, UE-3 must perform neighbour cell measurement for cell reselection.

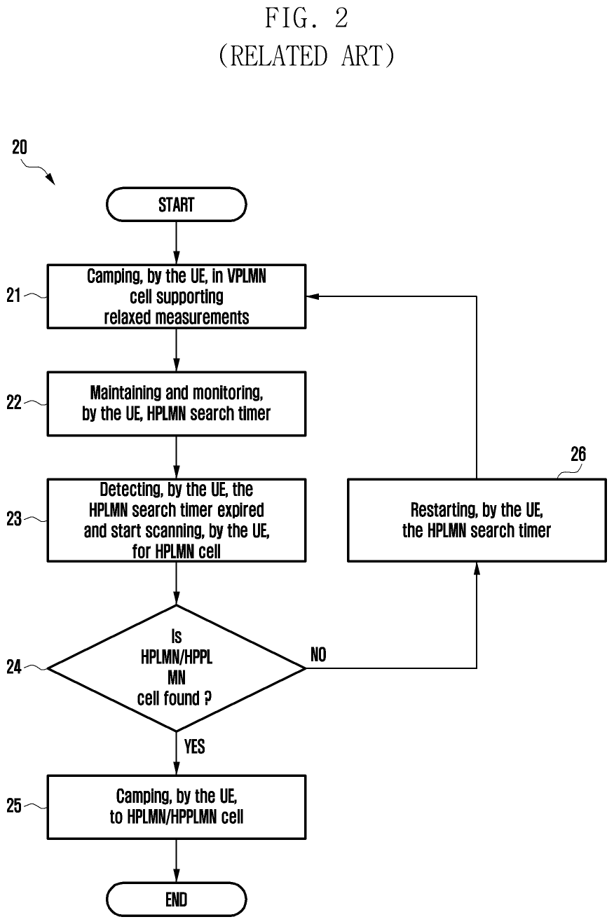

The method as described above in FIG. 1 does not use the aforementioned parameters (e.g., refer Table 2) to limit the RRM measurements in order to preserve power in the UEs throughout various standard operations. For example, when the UE is located in a visited public land mobile network (VPLMN) while roaming or experiencing limited service, the UE may continuously perform home PLMN (HPLMN) or higher-priority PLMN (HPPLMN) scanning in the background based on a timer for HPLMN camping, as described in conjunction with FIG. 2 and as discussed later in the description. The continuous scanning process consumes significant battery power regardless of the UE's low mobility and strong signal condition in the VPLMN cell (not at the cell edge).

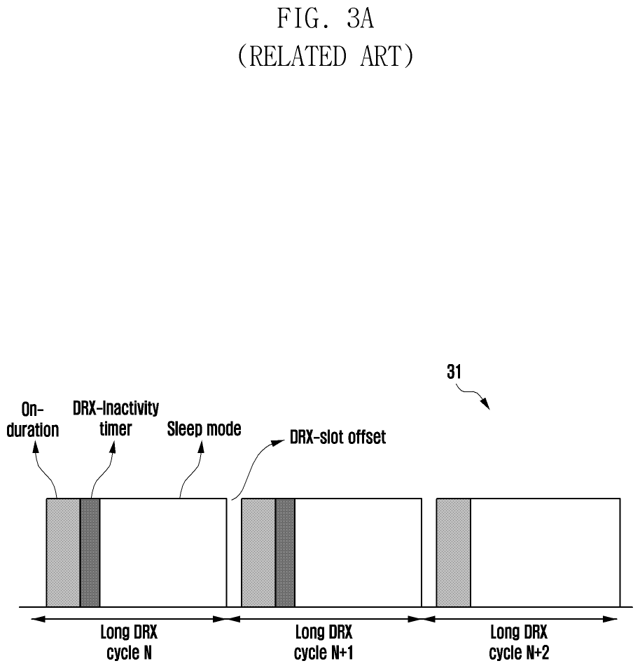

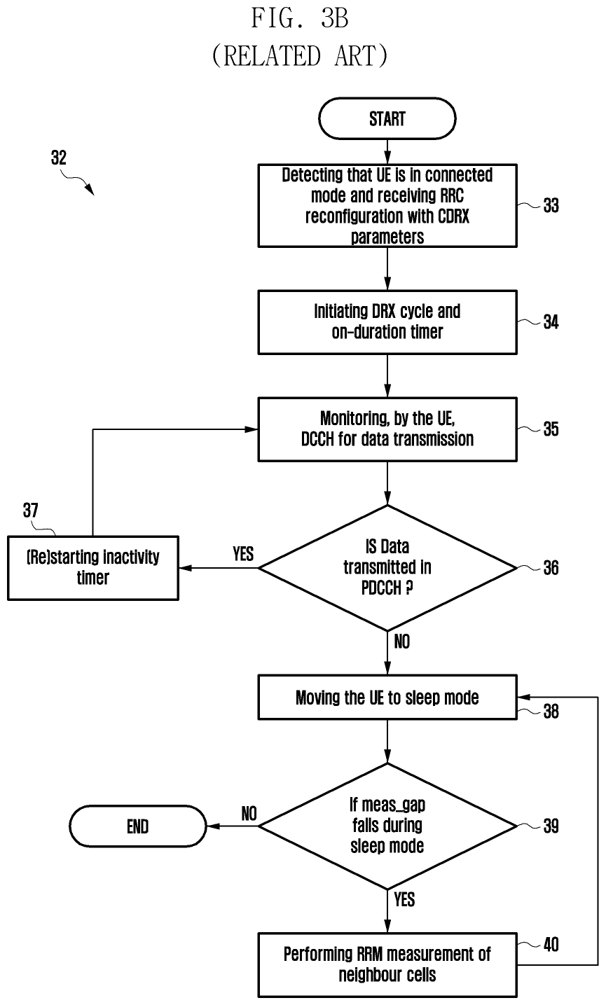

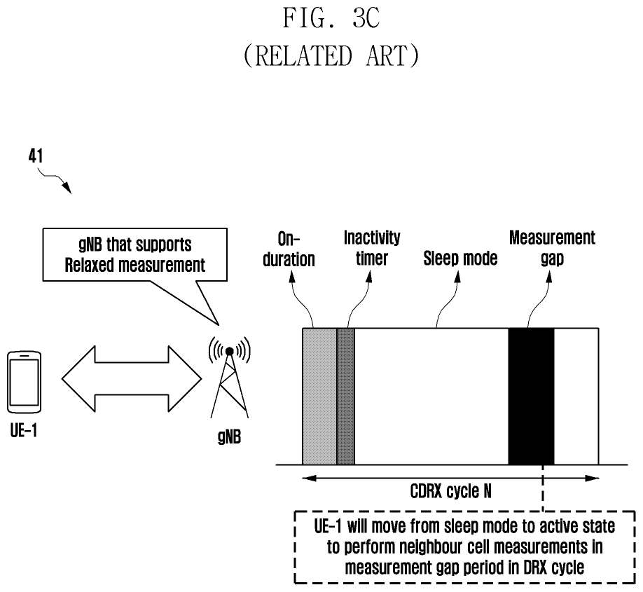

In another scenario, when a connected DRX (CDRX) is configured in the UE along with measurement gap(s), there are situations where the measurement gap(s) coincide with a CDRX sleep period. Consequently, the UE wakes up from a CDRX sleep to conduct inter-frequency or inter-radio access technology (Inter-RAT) measurements for the neighbouring cells, as described in conjunction with FIGS. 3B and 3C and as discussed later in the description. Additionally, the UE continues to perform HPLMN searches or wake up for measurement gap(s) even when the UE is in a strong signal area (not at the cell edge) and has low or no mobility, as described in conjunction with FIGS. 3B and 3C and as discussed later in the description, which leads to high power consumption and poor battery performance.

Thus, there lies a need to address the above-mentioned disadvantages or other shortcomings or at least provide an improved method for optimizing power in the UE.

Basic public land mobile network (PLMN) terminologies as discussed throughout the disclosure are listed in Table 3 below.

TABLE 3

| | |
|---|---|
| HPLMN | home PLMN (HPLMN) refers to the PLMN in which a user |
| | equipment (UE) is defined, and subscribers' profile is held. |
| | HPLMN value may be derived from international mobile subscriber |
| | identity (IMSI) of universal integrated circuit card (UICC). |
| RPLMN | The registered PLMN (RPLMN) is the PLMN on which the UE has |
| | performed a location registration successfully by tracking area |
| | update or attach procedure. During PLMN selection, the UE may |
| | prioritize to select the last registered RPLMN of the UE. |
| VPLMN | VPLMN refers to the PLMN ID of the roaming network in which |
| | the mobile subscriber has roamed when leaving their HPLMN. |
| HPPLMN | UE can perform periodic scans for a higher priority PLMN |
| | (HPPLMN) than the currently camped VPLMN. |
| | The scan period depends upon the value configured in the |
| | EF_HPPLMN file in the USIM. |
| EF_HPPLMN | “Higher Priority PLMN search period” value configured in the |
| | USIM |
| | The value configured in EF_HPPLMN in the USIM is in |
| | hexadecimal, and it specifies the integer multiple of 6 minutes as |
| | per 3GPP specification 22.011 |
| | For example-: |
| | if EF_HPPLMN = 1, UE searches for the higher priority cells every (1 × |
| | 6 minutes) = 6 minutes. |
| | if EF_HPPLMN = 2, UE searches for the higher priority cells every (2 × |
| | 6 minutes) = 12 minutes. |
| | if EF_HPPLMN = 50 (i.e., 50 Hex which is 80 decimal), UE searches for |
| | the higher priority cells every (80 × 6 minutes) = 480 minutes = 8 hours. |

For periodic HPLMN/HPPLMN scans, when the UE is camped on a roaming PLMN (i.e., VPLMN), the UE periodically does a background scan for the HPLMN or the HPPLMN. This process is also known as a background PLMN (BPLMN) search. A time interval between the periodic HPLMN scans may be set from 6 minutes to 8 hours, depending upon a value of “Higher Priority PLMN search period” (EF_HPPLMN) configured within the USIM (as per 3GPP TS 31.102 section 4.2.6 and 3GPP TS 22.011 Section 3.2.2.5).

FIG. 2 is a flow diagram illustrating a method 20 of the related art for a HPLMN scanning when a UE is camped on a VPLMN of a cellular network according to the related art.

Referring to FIG. 2, at operation 21, the method 20 of the related art includes detecting that the UE is camped in a roaming PLMN (VPLMN) cell that supports the relaxed measurement configuration. When the UE detects a VPLMN cell that supports the release-16 relaxed measurement feature, the UE may reduce a measurement frequency of a serving cell/neighbour cell for a cell reselection, but the UE may continue to do the BPLMN search regularly to camp in the HPLMN cell or the HPPLMN cell. At operation 22, the method 20 of the related includes maintaining and monitoring an HPLMN timer for the periodicity of an HPLMN scan or an HPPLMN scan. At operation 23, the method 20 of the related includes detecting that the HPLMN search timer is expired. When the HPLMN search timer expires, the UE may begin scanning for the HPLMN cell or the HPPLMN cell.

At operation 24, the method 20 of the related includes whether the HPLMN cell or the HPPLMN cell is located. At operation 25, the method 20 of the related includes detecting that the UE is camped to the HPLMN cell or the HPPLMN cell in response to determining that the HPLMN cell or the HPPLMN cell is located. At operation 26, the method 20 of the related includes restarting the HPLMN search timer in response to determining that the HPLMN cell or the HPPLMN cell is not located.

In the method 20 of the related, the periodicity of the HPLMN/HPPLMN scan depends on a value configured in EF_HPPLMN (Higher Priority PLMN search period) within the USIM of the UE. According to 3GPP TS 31.102 section 4.2.6, a basic periodicity is 6 minutes and the value configured in EF_HPPLMN specifies the integer multiple of 6 minutes. For example, if EF_HPPLMN=2, the UE may search for the higher priority cells every 12 minutes (2×6 minutes), and so on. As a result, the UE continuously performs periodic scans for the HPLMN cell or the HPPLMN cell during a roaming scenario. When the UE is camped in the roaming PLMN (VPLMN) cell that supports the relaxed measurement configuration (release-16 relaxed measurement and the UE is not located at the cell edge, as well as when there is no or low mobility, the UE continues to execute the BPLMN search on a regular basis, even if there is no likelihood of detecting the HPLMN cell or the HPPLMN cell.

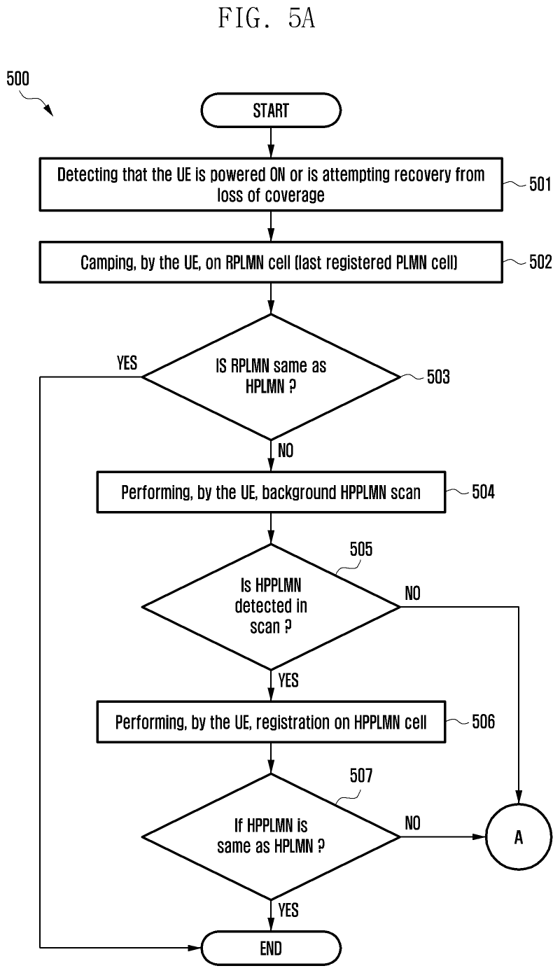

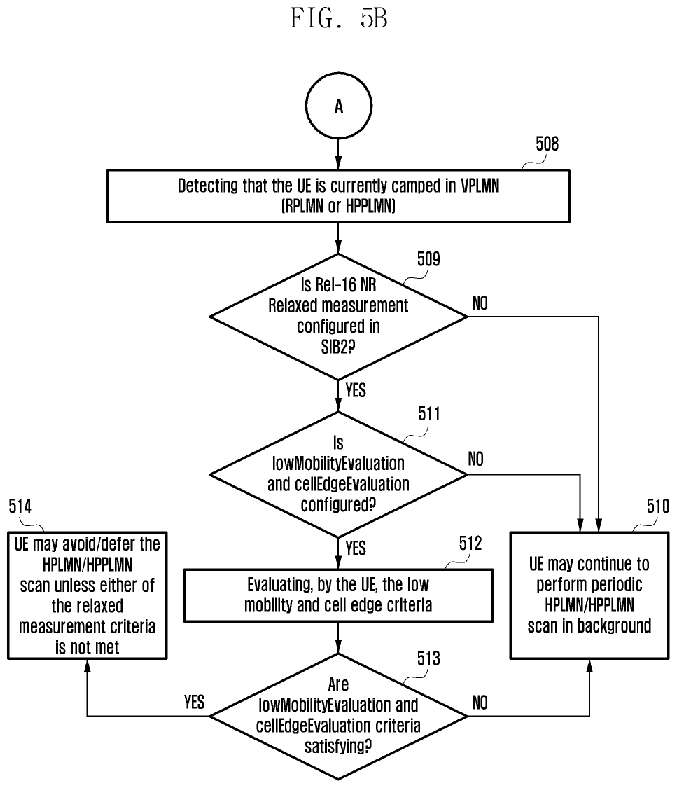

The periodic scans for the HPLMN or HPPLMN cells use too much power, which is undesirable. As a result, an alternative method to eliminate excessive power use is required, as described in conjunction with FIGS. 5A, 5B, 6B, 7A, 7B, and 8B.

FIG. 3A illustrates a connected mode discontinuous reception (CDRX) feature 31 according to the related art.

Referring to FIG. 3A, discontinuous reception (DRX) is a power-saving feature in 5G networks that enables the UE to enter a sleep mode (Off duration) during idle periods to conserve battery life and/or when a physical downlink control channel (PDCCH) is not required to be monitored. The UE may periodically wake up to check for incoming data and signals from the cellular network. In the 5G networks, there are two types of discontinuous reception (DRX). The first type is an idle mode DRX, and the second type is a connected mode DRX.

Each long DRX cycle (e.g., N, N+1, N+2, etc.) consists of an ON duration and an OFF duration. The cellular network can configure DRX parameters, as shown in Table 4, to the UE at a slot-level granularity within a subframe through an RRC reconfiguration message. The ON duration is a period in which the UE may stay awake and decode the PDCCH. If no data is received during the ON duration, the UE may go to the DRX sleep state (OFF duration), until the start of the next ‘On duration’ (long DRX cycle N+2). If data transmission is observed in the PDCCH during the ON duration, it implies that the UE may schedule mode data and hence initiate the DRX-inactivity timer. The UE may move to the DRX sleep state once no data is transmitted in the PDCCH during the DRX-inactivity timer (long DRX cycle N, N+1). The UE may start or restart the DRX-inactivity timer every time the PDCCH indicates a new Up Link (UL) or Down Link (DL) transmission, and the UE may stay in an active state and keep monitoring for the PDCCH until the expiry of the DRX-inactivity timer.

TABLE 4

| Parameters | Description |
|---|---|
| drx- | Indicates the amount of time at the beginning of |
| onDurationTimer | each DRX cycle (DRX ON) to decode the |
| | PDCCH during every DRX cycle before entering |
| | power-saving mode. |
| drx-InactivityTimer | Specifies the time period for which the UE should |
| | be active after successfully decoding the PDCCH |
| | indicating a new transmission. |
| drx- | Configure two parameters drx-LongCycle in ms |
| LongCycleStartOffset | and drx-StartOffset in multiples of 1 ms. |
| drx-LongCycle | Defines Long DRX Cycle length. |
| drx-StartOffset | Used to determine the starting subframe number |
| | within a DRX cycle. |
| drx-SlotOffset | Defines the start of ‘On Duration’ w.r.t the start |
| | of the subframe. |

FIG. 3B is a flow diagram illustrating a method 32 of the related for performing neighbour cell measurements with overlapping measurement gap(s) and CDRX sleep duration (i.e., off duration or sleep mode) according to the related art.

Referring to FIG. 3B, at operation 33, the method 32 of the related includes detecting that UE is in a connected mode and receiving the RRC reconfiguration message with the CDRX parameters, as shown in Table 4. At operation 34, the method 32 of the related includes initiating the DRX cycle and an on-duration timer. At operation 35, the method 32 of the related includes monitoring the PDCCH for the data transmission upon initiating the DRX cycle and the on-duration timer. At operation 36, the method 32 of the related includes determining whether the data is transmitted in the PDCCH. At operation 37, the method 32 of the related includes restarting the inactivity timer (e.g., DRX-inactivity timer) in response to determining that the data is transmitted in the PDCCH. At operation 38, the method 32 of the related includes moving the UE into the sleep mode in response to determining that the data is not transmitted in the PDCCH.

At operation 39, the method 32 of the related includes determining whether a measurement gap falls during the sleep mode. At operation 40, the method 32 of the related includes performing the RRM measurements for the neighbour cells in response to determining that the measurement gap falls during the sleep mode. The method 32 of the related then may perform operation 38 to operation 40.

In the connected mode (e.g., RRC connected mode), when the CDRX is configured, the UE moves to the sleep mode (DRX sleep state) when no data transmission is detected during the on-duration timer or the inactivity timer during the CDRX cycle. The UE may remain in a dormant state and not perform any data transmission while staying in the sleep mode of the CDRX cycle. The goal of CDRX configuration is to save UE's power in the connected mode. In the connected mode, for inter-frequency or inter-RAT measurements, the network configures the measurement gap to execute the measurement. The measurement gap(s) are essential for the inter-frequency or IRAT measurements since the UE's RF cannot tune to two separate frequencies at the same time.

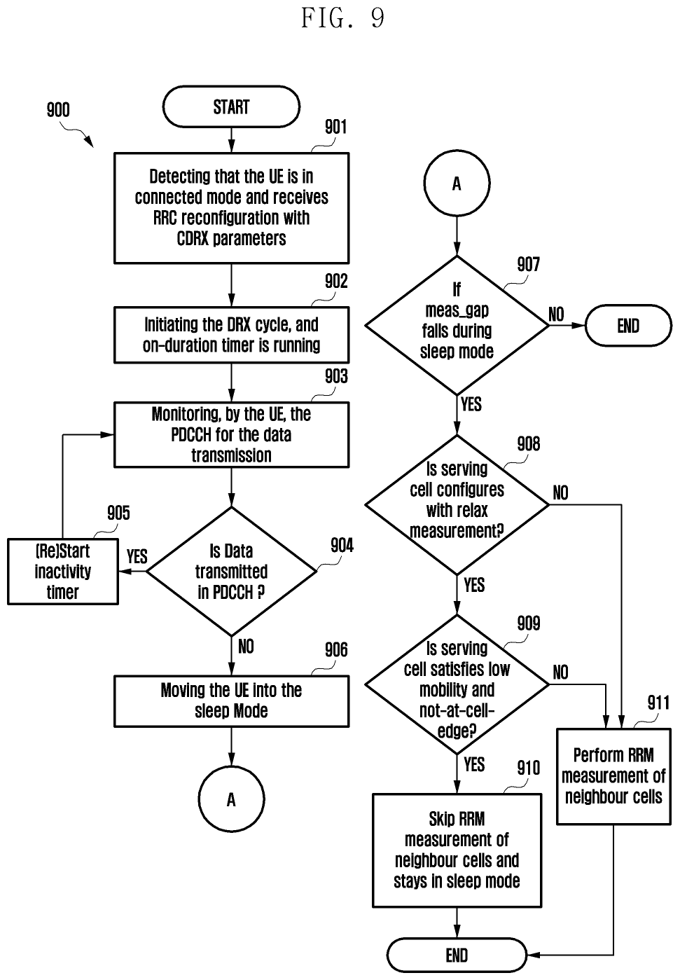

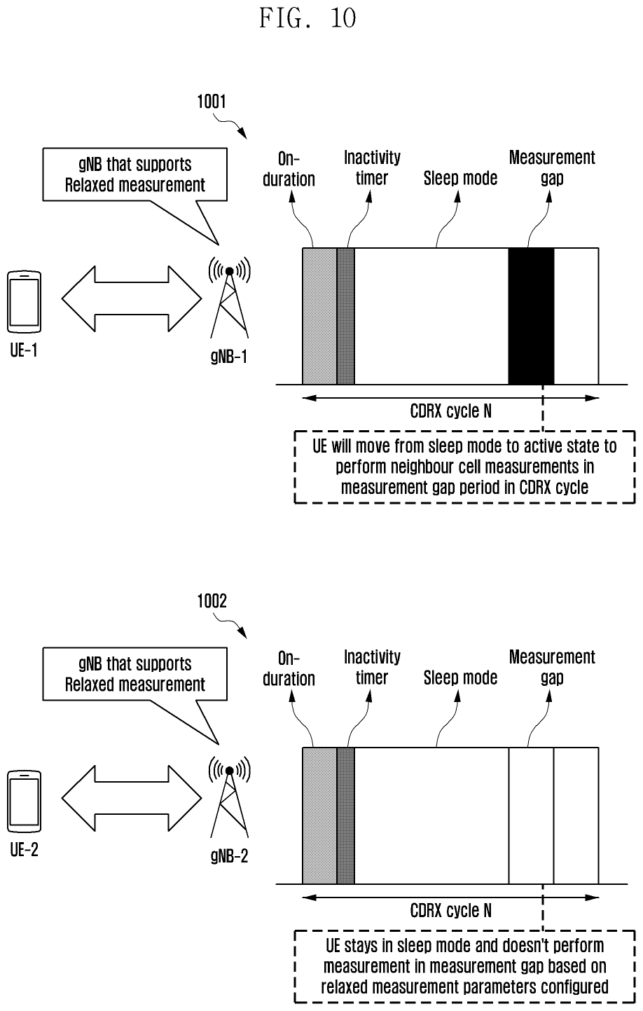

The measurement gap(s) can overlap with the CDRX sleep duration (i.e., Off duration) as well. The RRM measurements have higher priority than CDRX as measurements are mandatory to remain connected. During the CDRX cycle, if the measurement gap(s) coincide with the CDRX sleep duration, the UE will wake up from the sleep mode and move to the active state to perform the RRM measurements in the measurement gap, as described in conjunction with FIG. 3C. The UE switches on a radio frequency (RF) functionality and performs RF tuning based on configured frequency for neighbour cell measurements to perform the RRM measurements. The UE moves back to C the CDRX sleep duration after completion of the RRM measurements if sleep duration (sleep mode) is left in that CDRX cycle. Although the UE can detect cell edge or mobility conditions using the release-16 relaxed measurement feature, in the method 32 of the related, the UE continues to perform measurements in the measurement gap(s) which overlap with the CDRX sleep duration. Even when the UE is in strong signal (not in cell edge) and the low or no mobility, the UE wakes up during the measurement gap(s) coinciding with CDRX sleep where the signal condition of the neighbour cells is not going to change as the UE is not in the mobility. So, the method 32 of the related causes higher battery consumption in the UE and discards a chance of power reduction, which is undesirable. As a result, an alternative method to eliminate excessive power use is required, as described in conjunction with FIGS. 9 and 10.

FIG. 3C illustrates an overlapping scenario 41 of measurement gap(s) and a CDRX sleep duration according to the related art.

Referring to FIG. 3C, the UE (UE-1) in the RRC-connected mode is configured with the CDRX cycle by the network (i.e., gNB) and the network supports the release-16 relaxed measurement feature. After no data transmission is detected during the inactivity timer, the UE enters the sleep mode during the CDRX cycle. Additionally, the UE is configured with measurement gap(s) to perform the inter-frequency and inter-RAT measurements.

The measurement gap(s) may overlap with the CDRX sleep duration. When the measurement gap(s) coincides with the CDRX sleep duration, the UE may move to the active state to perform the RRM measurements. Even though the UE is in the low/no mobility and not in the cell edge which means that the serving or neighbour cells signal condition is less likely to change, the UE disrupts its CDRX sleep duration to perform the RRM measurements. After the RRM measurements, if the CDRX sleep duration is remaining, then it will move to CDRX sleep till the CDRX cycle is not over. Despite the fact that the UE can detect the cell edge or mobility condition by using the release-16 relaxed measurement function, the UE continues to make RRM measurements in the measurement gap(s) that overlap with the CDRX sleep duration by waking up from sleep mode. As a result, in the method 32 of the related, the UE is unable to make use of the opportunity for power-saving optimization, which is undesirable. As a result, an alternative method to eliminate excessive power use is required, as described in conjunction with FIGS. 9 and 10.

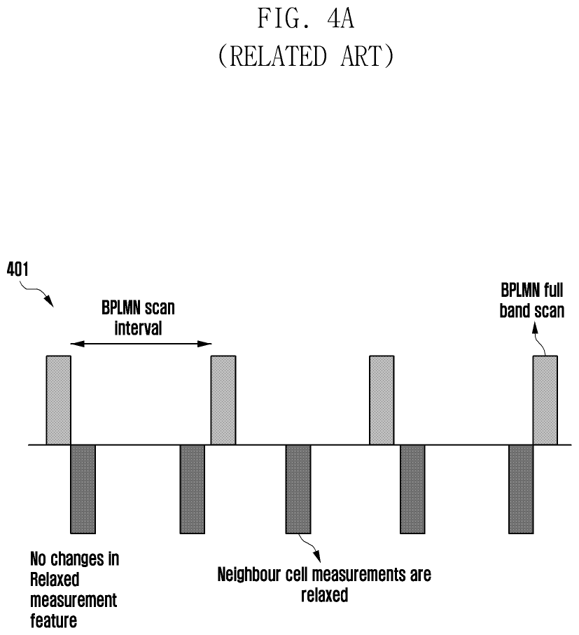

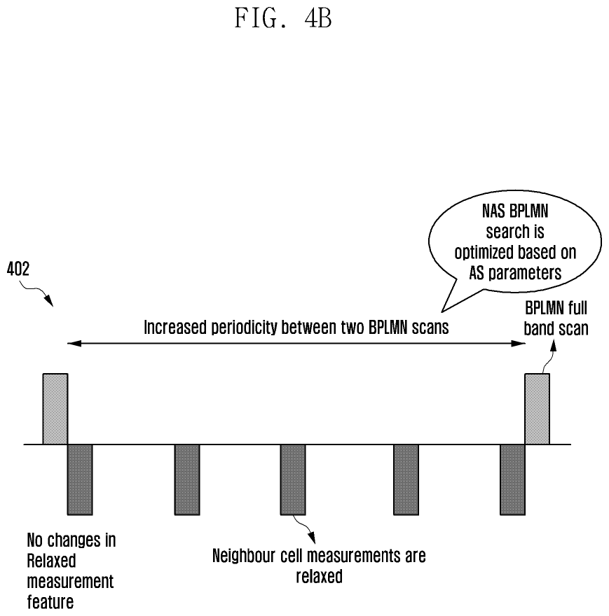

To address these challenges, a method provides a unique strategy for optimizing power in the UE, as described in conjunction with FIGS. 4A, 4B, 5A, 5B, 6A, 6B, 7A, 7B, 8A, 8B, 9 to 14, 15A, and 15B.

Referring now to the drawings, and more specifically to FIGS. 4A, 4B, 5A, 5B, 6A, 6B, 7A, 7B, 8A, 8B, 9 to 14, 15A, and 15B, where similar reference characters consistently represent equivalent aspects throughout the figures.

FIG. 4A illustrates a graphical representation depicting a periodicity between two BPLMN scans with reference to relaxed measurement features, according to the related art.

Referring to FIG. 4A, in a method 401 of the related, the UE executes periodic BPLMN full-band scans even when the mobility is low and the signal is strong or good, which is undesirable.

FIG. 4B illustrates a graphical representation depicting a periodicity between two BPLMN scans with reference to the relaxed measurement features, according to an embodiment of the disclosure.

Referring to FIG. 4B, to overcome this issue (refer to FIG. 4A), a method 402 employs a novel strategy for optimizing power in the UE, in which the UE defers periodic BPLMN scans by increasing the periodicity between two BPLMN scans. The method 402 may execute multiple steps or use multiple features to optimize the power in the UE, which are listed in the following paragraphs.

In one or more embodiments of the disclosure, in the method 402, the UE may determine its mobility state and location information with respect to a cell edge using one or more SIB2 parameters. Additionally, the method 402 may use one or more 3GPP-defined access stratum (AS) parameters to optimize a non-access stratum (NAS) procedure of background PLMN (BPLMN) scan when the UE is camped in the roaming PLMN (i.e., VPLMN) to reduce full band scanning, as described in conjunction with FIGS. 5A, 5B, 6B, 7A, 7B, and 8B. In other words, when the UE is in the low mobility and the strong or good signal, a probability of finding other neighbour cells is almost negligible. So, the UE defers periodic BPLMN scans by increasing the periodicity between two BPLMN scans. Additionally, the UE may optimize measurements overlapping with CDRX sleep duration to save power, as described in conjunction with FIGS. 9 and 10.

In the method 402, when the UE is camped in the VPLMN, the UE periodically performs a full band scan to discover the HPLMN. However, in the method 402, the UE may optimize a NAS procedure, based on the mobility state and location information using relaxed measurement AS parameters, by deferring/restricting unnecessary background full band scans for the HPLMN search as these scans may not result in any PLMN change. As a result, method 402 achieves optimizing power in the UE, as described in conjunction with FIGS. 5A, 5B, 6B, 7A, 7B, and 8B.

In the method 402, the UE performs the inter-frequency measurements irrespective of the CDRX sleep duration. However, in the method 402, the UE may avoid unnecessary wakeups, based on the mobility state and location information using the relaxed measurement AS parameters, in between the CDRX sleep duration for measurements as these may not provide any significant result for measurement reporting. As a result, the method 402 achieves optimizing power in the UE, as described in conjunction with FIGS. 9 and 10.

According to cell edge evaluation in relaxed measurement, in SIB-2, the network (e.g., gNB) may broadcast the Relaxed measurement parameters through which the UE may detect whether the UE is in the low mobility and not in cell edge condition.

To detect the cell edge condition, it is important to note that distance is not a determining factor. The ability to detect how far or near the UE is to the network is not based on distance alone. Instead, the condition given for cell edge and signal strength measurement is utilized to determine whether the UE is near the cell edge or not, as described in Table 5.

```
TABLE 5
cellEdgeEvaluation-r16 SEQUENCE
  {
  s-SearchThresholdP-r16 ReselectionThreshold, OPTIONAL -- Need R
  s-SearchThresholdQ-r16 ReselectionThresholdQ OPTIONAL -- Need R
  } OPTIONAL, -- Need R
  The relaxed measurement criterion for UE not at cell edge is fulfilled
  when:
  - Srxlev > SSearchThresholdP, and,
  - Squal > SSearchThresholdQ, if SSearchThresholdQ is configured,
  Where:
  - Srxlev = current Srxlev value (RSRP) of the serving cell (dB).
  - Squal = current Squal value (RSRQ) of the serving cell (dB).
```

In one example scenario, the gNB may broadcast the relaxed measurement IE in the SIB2 with the cell edge evaluation IE that only includes s-SearchThresholdP-r16 and has a value of −105 dB. Upon detecting its current RSRP value as −100 dB, indicating that the UE1 is to not be in the cell edge. Conversely, a UE2 detects its current RSRP value as −106 dB, indicating that the UE2 is in the cell edge to gNB1. These results demonstrate the effectiveness of the evaluation IE in accurately determining a UE's location in relation to the cell edge.

In another example scenario, the gNB may broadcast the relaxed measurement IE in the SIB2 with the cell edge evaluation IE. This includes the s-SearchThresholdP-r16 with a value of −105 dB and s-SearchThresholdQ-r16 with a value of −15 dB. Upon detection, UE-1 may report its current RSRP value as −100 dB and RSRQ value as −12 dB, indicating that the UE-1 is not in the cell edge. On the other hand, the UE-2 may detect its current RSRP value as −108 dB and RSRQ value as −12 dB, indicating that the UE-2 is in the cell edge to the gNB. Similarly, the UE-3 detects its current RSRP value as −108 dB and RSRQ value as −18 dB, indicating that the UE-3 is also in the cell edge to the gNB.

FIGS. 5A and 5B are flow diagrams illustrating a method for HPLMN scanning when a UE is camped on a VPLMN of a cellular network according to various embodiments of the disclosure.

Referring to FIGS. 5A and 5B, at operation 501, a method 500 includes detecting that the UE is powered ON or is attempting recovery from loss of coverage. At operation 502, the method 500 includes camping, by the UE, on an RPLMN cell (last registered PLMN cell). At operation 503, the method 500 includes determining, upon camping on the RPLMN cell, whether the RPLMN cell is the same as the HPLMN cell. At operation 504, the method 500 includes performing a background HPPLMN scan in response to determining that the RPLMN cell is not the same as the HPLMN cell. Further, the UE does not perform any additional steps or scanning process when the UE detects that the RPLMN cell is the same as the HPLMN cell, and the UE may camp on the HPLMN cell.

At operation 505, the method 500 includes determining whether the HPPLMN cell is detected in the background HPPLMN scan. At operation 506, the method 500 includes performing a registration process on the HPPLMN cell in response to determining that the HPPLMN cell is detected in the background HPPLMN scan. The method 500 includes performing one or more operations (i.e., 508 to 514) to optimize the power in the UE in response to determining that the HPPLMN cell is not detected in the background HPPLMN scan. At operation 507, the method 500 includes determining, upon successful registration on the HPPLMN cell, whether the HPPLMN cell is the same as the HPLMN cell. Further, the UE does not perform any additional steps or scanning process (background PLMN scans) when the UE detects that the HPPLMN cell is the same as the HPLMN cell, and the UE may camp on the HPLMN cell. The method 500 includes performing, after registration, one or more operations (i.e., 508 to 514) to optimize the power in the UE in response to determining that the HPPLMN cell is not the same as the HPLMN cell.

At operation 508, the method 500 includes detecting that the UE is currently camped in VPLMN (RPLMN or HPPLMN). At operations 509 to 514, upon detecting that the UE is currently camped in VPLMN, the method 500 includes validating or checking for one or more conditions, by the UE, to optimize the power in the UE, which are listed below.

Are Rel-16 NR Relaxed measurements IE present in the SIB2?

Are lowMobilityEvaluation parameter(s) and cellEdgeEvaluation parameter(s) configured in the SIB2?

By using the lowMobilityEvaluation parameter(s), is the UE in a low mobility state?

By using the cellEdgeEvaluation parameters(s), is the UE not located at the cell edge?

At operation 509, the method 500 includes determining whether the Rel-16 NR Relaxed measurements IE are present in the SIB2, upon detecting that the UE is currently camped in VPLMN. At operation 510, the method 500 includes performing, by the UE, a periodic HPLMN scan or HPPLMN scan in the background as per timer value configured in EF_HPPLMN in response to determining that the Rel-16 NR Relaxed measurements IE are not present in the SIB2. At operation 511, the method 500 includes determining whether the lowMobilityEvaluation parameter(s) and cellEdgeEvaluation parameter(s) are configured in the SIB2 in response to determining that the Rel-16 NR Relaxed measurements IE are present in the SIB2. The method 500 includes performing, by the UE, the periodic HPLMN scan or HPPLMN scan in the background as per timer value configured in EF_HPPLMN in response to determining that the lowMobilityEvaluation parameter(s) and cellEdgeEvaluation parameter(s) are not configured in the SIB2.

At operation 512, the method 500 includes evaluating, by the UE, the low mobility state and cell edge criteria in response to determining that the lowMobilityEvaluation parameter(s) and cellEdgeEvaluation parameter(s) are configured in the SIB2. At operation 513, the method 500 includes determining whether the UE is in the low mobility state and/or the UE is not located at the cell edge. The method 500 includes performing, by the UE, the periodic HPLMN scan or HPPLMN scan in the background as per timer value configured in EF_HPPLMN in response to determining that the UE is not in the low mobility state and/or UE is located at the cell edge. At operation 514, the method 500 includes avoiding or deferring the HPLMN scan or the HPPLMN scan in response to determining that the UE is in the low mobility state and/or the UE is not located at the cell edge. In other words, the UE may skip the HPLMN scan or HPPLMN scan in the background when all the conditions (i.e., conditions of operations 509, 511, and 513) are satisfied. As a result, the UE may significantly improve battery performance and power optimization.

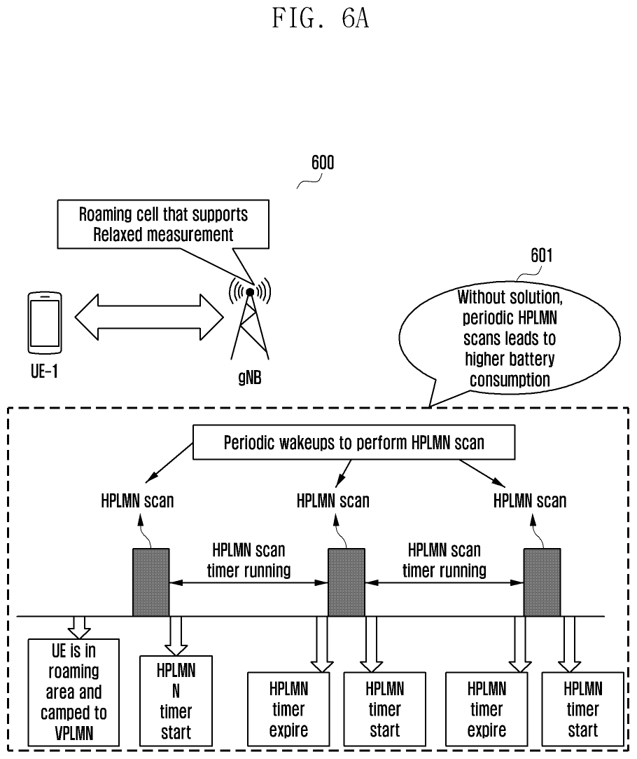

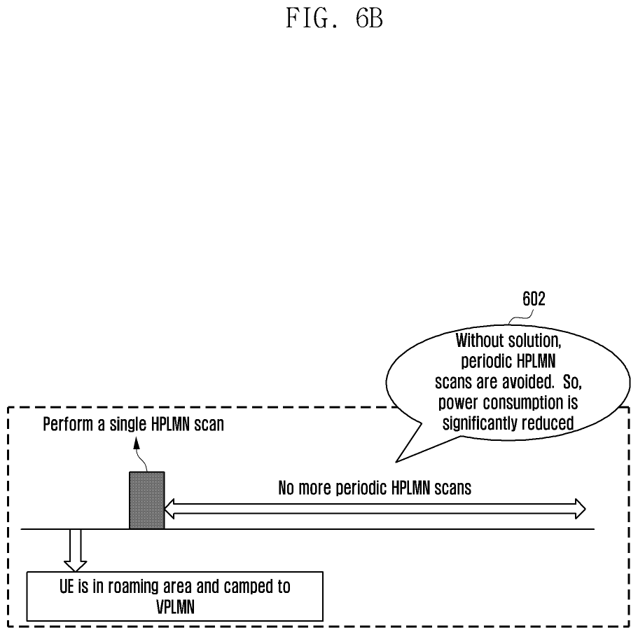

FIG. 6A illustrates a graphical representation depicting a periodicity between two BPLMN scans with reference to relaxed measurement features according to the related art.

Referring to FIG. 6A, in a method 601 of the related, the UE executes periodic BPLMN full-band scans even when the mobility is low and the signal is strong or good, which is undesirable.

FIG. 6B illustrates a graphical representation depicting a periodicity between two BPLMN scans with reference to relaxed measurement features according to an embodiment of the disclosure.

Referring to FIG. 6B, to overcome this issue (refer to FIG. 6A), a method 602 employs the novel strategy for optimizing power in the UE, in which the UE defers periodic BPLMN scans.

In one example scenario 600, the HPLMN (e.g., gNB) of the UE is 123-123. The UE is currently in a roaming area where coverage of the HPLMN 123-123 is not present. However, the UE is capable of camping to an RPLMN 456-456. In a SIM card of the UE, the EF_HPPLMN is set to 3. This means the UE may scan for PLMN 123-123 after every 3*6 minutes=18 minutes. The roaming PLMN 456-456 supports the configuration of relaxed measurements (i.e., Relaxed measurements IE with the lowMobilityEvaluation and the cellEdgeEvaluation are present in the SIB2). When the UE has just been powered ON, the UE first attempts to camp to the RPLMN 456-456. After camping to RPLMN 456-456, the UE may perform a background scan to check the presence of any other higher-priority PLMN (i.e., HPLMN 123-123). As the UE is currently in an area where coverage of the HPLMN 123-123 is not present, the UE may not detect any HPLMN cell during this background scan.

As per the method 602, the UE may now check for relaxed measurement criteria on the currently camped RPLMN 456-456. Based on the relaxed measurements criteria, if the UE detects that the UE is in the low mobility state and not in the cell edge condition, the UE may decide to skip any further background HPLMN scan. The UE may continue to skip the periodic HPLMN scan or HPPLMN scan in the background until either of the relaxed measurement criteria (i.e., low mobility state and cell edge) are not met. As the unnecessary periodic HPLMN scan or HPPLMN scan is avoided during the low mobility state and not in cell-edge conditions, the method 602 allows the UE to significantly improve battery performance and better power optimization.

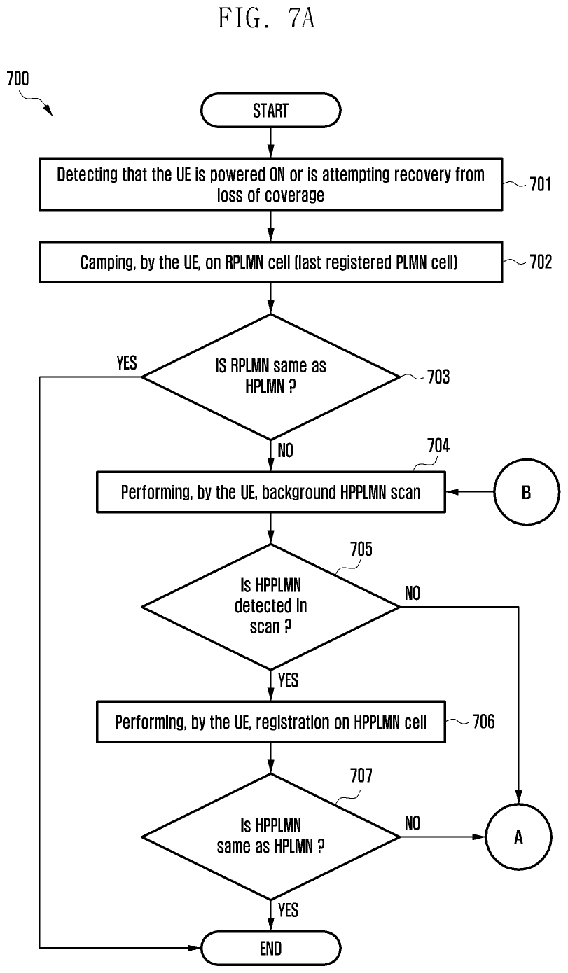

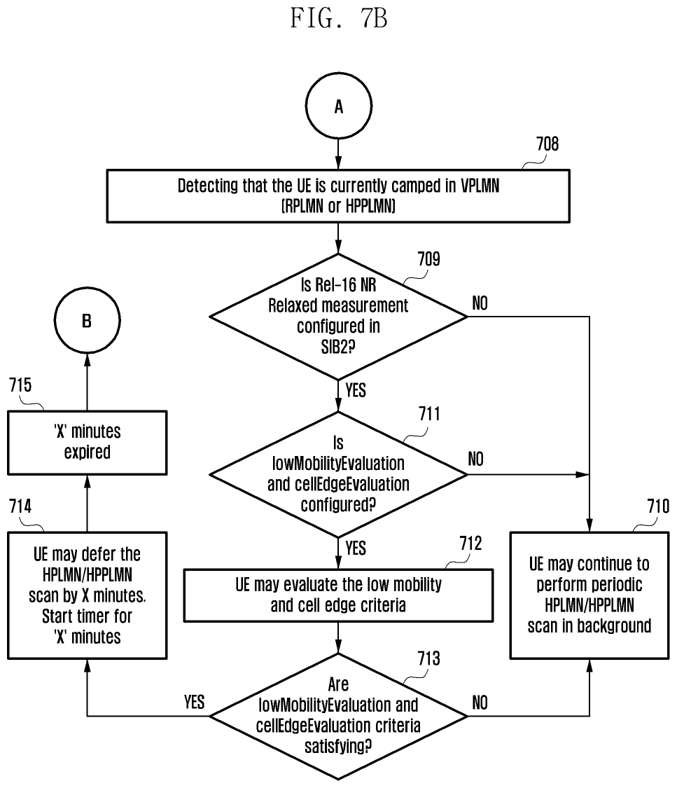

FIGS. 7A and 7B are flow diagrams illustrating a method for HPLMN scanning when a UE is camped on a VPLMN of a cellular network according to various embodiments of the disclosure.

Referring to FIGS. 7A and 7B, at operation 701, a method 700 includes detecting that the UE is powered ON or is attempting recovery from loss of coverage. At operation 702, the method 700 includes camping, by the UE, on the RPLMN cell (last registered PLMN cell). At operation 703, the method 700 includes determining, upon camping on the RPLMN cell, whether the RPLMN cell is the same as the HPLMN cell. At operation 704, the method 700 includes performing the background HPPLMN scan in response to determining that the RPLMN cell is not the same as the HPLMN cell. Further, the UE does not perform any additional steps or scanning process when the UE detects that the RPLMN cell is the same as the HPLMN cell, and the UE may camp on the HPLMN cell.

At operation 705, the method 700 includes determining whether the HPPLMN cell is detected in the background HPPLMN scan. At operation 706, the method 700 includes performing the registration process on the HPPLMN cell in response to determining that the HPPLMN cell is detected in the background HPPLMN scan. The method 700 includes performing one or more operations (i.e., 708 to 715) to optimize the power in the UE in response to determining that the HPPLMN cell is not detected in the background HPPLMN scan. At operation 707, the method 500 includes determining, upon successful registration on the HPPLMN cell, whether the HPPLMN cell is the same as the HPLMN cell. Further, the UE does not perform any additional steps or scanning process (background PLMN scans) when the UE detects that the HPPLMN cell is the same as the HPLMN cell, and the UE may camp on the HPLMN cell. The method 700 includes performing, after registration, one or more operations (i.e., 708 to 715) to optimize the power in the UE in response to determining that the HPPLMN cell is not the same as the HPLMN cell.

At operation 708, the method 700 includes detecting that the UE is currently camped in VPLMN (RPLMN or HPPLMN). At operations 709 to 715, upon detecting that the UE is currently camped in the VPLMN, the method 700 includes validating or checking for one or more conditions, by the UE, to optimize the power in the UE, which are listed below.

Are Rel-16 NR Relaxed measurements IE present in the SIB2?

Are lowMobilityEvaluation parameter(s) and cellEdgeEvaluation parameter(s) configured in the SIB2?

By using the lowMobilityEvaluation parameter(s), is the UE in the low mobility state?

By using the cellEdgeEvaluation parameters(s), is the UE not located at the cell edge?

At operation 709, the method 700 includes determining whether the Rel-16 NR relaxed measurements IE is present in the SIB2, upon detecting that the UE is currently camped in VPLMN. At operation 710, the method 700 includes performing, by the UE, the periodic HPLMN scan or HPPLMN scan in the background as per timer value configured in EF_HPPLMN in response to determining that the Rel-16 NR Relaxed measurements IE are not present in the SIB2. At operation 711, the method 700 includes determining whether the lowMobilityEvaluation parameter(s) and cellEdgeEvaluation parameter(s) are configured in the SIB2 in response to determining that the Rel-16 NR Relaxed measurements IE are present in the SIB2. The method 700 includes performing, by the UE, the periodic HPLMN scan or HPPLMN scan in the background as per timer value configured in EF_HPPLMN in response to determining that the lowMobilityEvaluation parameter(s) and cellEdgeEvaluation parameter(s) are not configured in the SIB2.

At operation 712, the method 700 includes evaluating, by the UE, the low mobility state and cell edge criteria in response to determining that the lowMobilityEvaluation parameter(s) and cellEdgeEvaluation parameter(s) are configured in the SIB2. At operation 713, the method 700 includes determining whether the UE is in the low mobility state and/or the UE is not located at the cell edge. The method 700 includes performing, by the UE, the periodic HPLMN scan or HPPLMN scan in the background as per timer value configured in EF_HPPLMN in response to determining that the UE is not in the low mobility state and/or UE is located at the cell edge. At operation 714, the method 700 includes avoiding or deferring the HPLMN scan or the HPPLMN scan for “x” minutes in response to determining that the UE is in the low mobility state and/or the UE is not located at the cell edge. At operation 715, the method 700 includes detecting the “x” minutes that are expired. Upon expiration of the “x” minutes, the method 700 may perform one or more operations (i.e., 704 to 715) to optimize the power in the UE or initiate the process for the HPLMN scan or HPPLMN scan.

In other words, instead of skipping the HPLMN scan or HPPLMN scan, the UE may extend a time period between each HPLMN scan or HPPLMN scan by “x” minutes, where “x” is the timer period extension between each HPLMN scan or HPPLMN scan, when all the conditions (i.e., conditions of operations 709, 711, and 713) are satisfied. As a result, the UE may significantly improve battery performance and power optimization. For example, when the UE is in the low mobility state and not in the cell edge scenario, the UE may perform the HPLMN scan or HPPLMN scan every “x” minutes, where the value of “x” is a much higher value than the periodicity obtained from EF_HPPLMN.

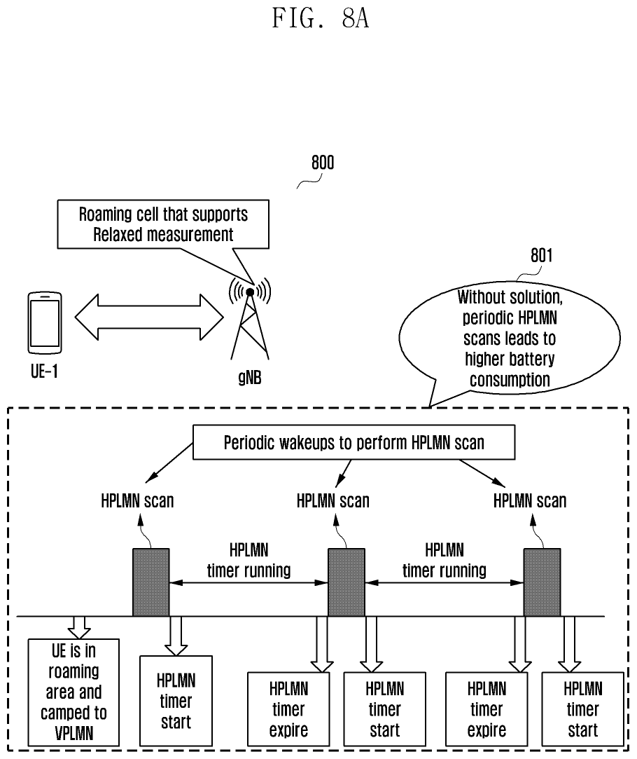

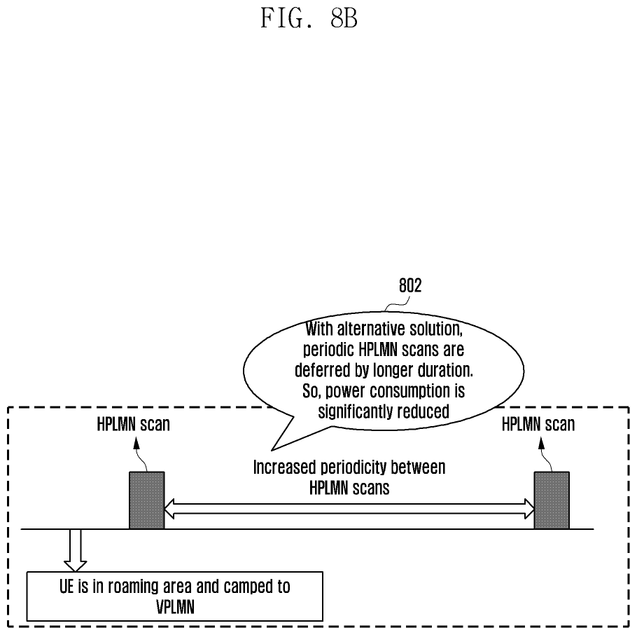

FIG. 8A illustrates a graphical representation depicting a periodicity between two BPLMN scans with reference to relaxed measurement features according to the related art.

Referring to FIG. 8A, in a method 801 of the related, the UE executes periodic BPLMN full-band scans even when the mobility is low and the signal is strong or good, which is undesirable.

FIG. 8B illustrates a graphical representation depicting a periodicity between two BPLMN scans with reference to the relaxed measurement features, according to an embodiment of the disclosure.

Referring to FIG. 8B, to overcome this issue (refer to FIG. 8A), a method 802 employs the novel strategy for optimizing power in the UE, in which the UE defers periodic BPLMN scans by increasing the periodicity between two HPLMN scans by using the “x” timer.

In one example scenario 800, the HPLMN (e.g., gNB) of the UE is 123-123. The UE is currently in a roaming area where coverage of the HPLMN 123-123 is not present. However, the UE is capable of camping to an RPLMN 456-456. In a SIM card of the UE, the EF_HPPLMN is set to 3. This means the UE may scan for PLMN 123-123 after every 3*6 minutes=18 minutes. The roaming PLMN 456-456 supports the configuration of relaxed measurements (i.e., Relaxed measurements IE with the lowMobilityEvaluation and the cellEdgeEvaluation are present in the SIB2). When the UE has just been powered ON, the UE first attempts to camp to the RPLMN 456-456. After camping to RPLMN 456-456, the UE may perform a background scan to check the presence of any other higher-priority PLMN (i.e., HPLMN 123-123). As the UE is currently in an area where coverage of the HPLMN 123-123 is not present, the UE may not detect any HPLMN cell during this background scan.

As per the method 802, the UE may now check for relaxed measurement criteria on the currently camped RPLMN 456-456. Based on the relaxed measurements criteria, if the UE detects that the UE is in the low mobility state and not in the cell edge condition, the UE may decide to HPLMN scan or HPPLMN scan, for example, for every 36 minutes (based on pre-configured HPPLMN scan timer value). The UE may continue to perform the modified HPLMN scan or HPPLMN scan in the background until either of the relaxed measurement criteria (i.e., low mobility state and cell edge) are not met. As the unnecessary periodic HPLMN scan or HPPLMN scan is extended during the low mobility state and not in cell-edge conditions, the method 802 allows the UE to significantly improve battery performance and better power optimization.

FIG. 9 is a flow diagram illustrating a method for performing neighbour cell measurements with overlapping measurement gap(s) and CDRX sleep duration according to an embodiment of the disclosure.

Referring to FIG. 9, at operation 901, a method 900 includes detecting that the UE is in the RRC connected mode and receiving the RRC reconfiguration with the CDRX parameters. At operation 902, the method 900 includes initiating the DRX cycle and detecting that the on-duration timer (e.g., inactivity timer) is running. At operation 903, the method 900 includes monitoring, by the UE, the PDCCH for the data transmission. At operation 904, the method 900 includes determining whether the data is transmitted in the PDCCH. At operation 905, the method 900 includes restarting the inactivity timer in response to determining that the data is transmitted in the PDCCH. At operation 906, the method 900 includes moving the UE into the sleep mode.

At operations 907 and 908, the method 900 includes determining whether the serving cell configures with the relax measurement when the measurement gap(s) falls during the sleep mode. At operation 911, the method 900 includes performing the RRM measurement of the neighbour cells in response to determining that the serving cell does not configure with the relax measurement. At operation 909, the method 900 includes determining whether the serving cell satisfies the low mobility state and not at the cell edge in response to determining that the serving cell configures with the relax measurement. At operation 911, the method 900 includes performing the RRM measurement of the neighbour cells in response to determining that the serving cell does not satisfy the low mobility state and is not at the cell edge. At operation 910, the method 900 includes skipping the RRM measurement of the neighbour cells and staying in the sleep mode in response to determining that the serving cell satisfies the low mobility state and is not at the cell edge.

In the method 900, while the UE is in the RRC connected mode, if the measurement gap coincides with the CDRX sleep duration, the UE may need to check about serving cell configuration on relax measurement support before performing the neighbour cell measurements in the coincided measurement gap. If the serving cell is configured with the relaxed measurement (Release 16 IE), the UE may need to evaluate the criteria for the low mobility state and not at the cell edge based on the configured relax measurement parameters in the SIB2. When the UE satisfies these criteria, the UE may skip performing the neighbour cell measurements in the measurement's gaps coinciding with the CDRX sleep duration.

In other words, when the UE is in the low or no mobility state and not near the cell edge, a change in the serving and neighbouring cells' probability signal condition is less likely. Because the signal state will be almost identical, eliminating the CDRX sleep interruption due to the measurement gap will save power. After completing the CDRX sleep time, the UE may perform the RRM measurements in the next measurement gap. The neighbour cell measurement readings will remain comparable due to the low mobility state. Due to the low mobility state, the neighbour cell measurement values will remain to be similar. With the method 900, the UE may decide whether to perform the RRM measurements or not for the coinciding cases with the CDRX sleep duration and save the power when the criteria are met. The method 900 improves the battery performance and power consumption efficiency.

FIG. 10 illustrates a difference between a method 902 and a method 901 of the related for performing neighbour cell measurements with overlapping measurement gap(s) and CDRX sleep duration according to an embodiment of the disclosure.

Referring to FIG. 10, in one scenario, two UEs (i.e., UE-1 and UE-2) may camp on and register with the gNB1 and gNB2 respectively, where both gNB1 and gNB2 support the relaxed measurement.

In a method 1001 of the related, after no data transmission is detected in the inactivity timer during the CDRX cycle, the UE-1 enters sleep mode. When the measurement gap collapses during the CDRX cycle's sleep mode, the UE-1 enters the active state and executes configured neighbour cell measurements. Because the UE-1 does not evaluate the cell edge or mobility condition when the measurement gaps coincide with the CDRX sleep duration, the measurement is continued by waking up in the middle of the sleep mode.

In a method 1002, the UE-2 may detect the low or no mobility state and not in the cell edge condition using the relaxed measurement parameters and may determine the current mobility situation. Once no cell edge and low mobility criteria are met, the UE-2 may select to skip the measurement gap which coincides with the CDRX sleep duration as the signal condition of neighbour cells will not be changing due to UE's mobility condition. With the method 1002, the UE-2 may avoid waking up during the CDRX sleep duration while the UE-1 continuously disrupts the CDRX sleep duration whenever measurement gaps coincide. Using the method 1002, the UE-2 may reduce the power consumption while the UE-1 continues to consume a higher power. As a result, the method 1002 may increase the battery performance of the UE-2.

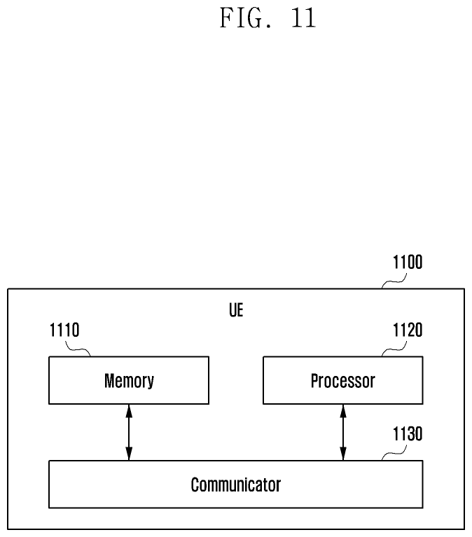

FIG. 11 illustrates a block diagram of a UE for optimizing power consumption according to an embodiment of the disclosure.

Referring to FIG. 11, examples of a UE 1100 include but are not limited to a smartphone, a tablet computer, a Personal Digital Assistance (PDA), an Internet of Things (IoT) device, a wearable device, or any similar communication device, etc. The UE 1100 may also be referred to as the communication device without any deviation from the scope of the disclosure.

In an embodiment of the disclosure, the UE 1100 comprises a memory 1110, a processor 1120, and a communicator 1130.

In an embodiment of the disclosure, the memory 1110 stores instructions to be executed by the processor 1120 for optimizing power in the UE 1100, as discussed throughout the disclosure. The memory 1110 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 1110 may, in some examples, be considered a non-transitory storage medium. The term “non-transitory” may indicate that the storage medium is not embodied in a carrier wave or a propagated signal. However, the term “non-transitory” should not be interpreted as the memory 1110 is non-movable. In some examples, the memory 1110 can be configured to store larger amounts of information than the memory. In certain examples, a non-transitory storage medium may store data that can, over time, change (e.g., in Random Access Memory (RAM) or cache). The memory 1110 can be an internal storage unit, or it can be an external storage unit of the UE 1100, a cloud storage, or any other type of external storage.

The processor 1120 communicates with the memory 1110, and the communicator 1130. The processor 1120 is configured to execute instructions stored in the memory 1110 and to perform various processes for optimizing power in the UE 1100, as discussed throughout the disclosure. The processor 1120 may include one or a plurality of processors, maybe a general-purpose processor, such as a central processing unit (CPU), an application processor (AP), or the like, a graphics-only processing unit, such as a graphics processing unit (GPU), a visual processing unit (VPU), and/or an Artificial intelligence (AI) dedicated processor, such as a neural processing unit (NPU).

The communicator (or a transceiver) 1130 is configured for communicating internally between internal hardware components and with external devices (e.g., server) via one or more networks (e.g., radio technology). The communicator 1130 includes an electronic circuit specific to a standard that enables wired or wireless communication.

The processor 1120 is implemented by processing circuitry, such as logic gates, integrated circuits, microprocessors, microcontrollers, memory circuits, passive electronic components, active electronic components, optical components, hardwired circuits, or the like, and may optionally be driven by firmware. The circuits may, for example, be embodied in one or more semiconductor chips, or on substrate supports, such as printed circuit boards and the like.

In one or more embodiments of the disclosure, the processor 1120 is configured to receive from the network (e.g., gNB), one or more relaxed measurement parameters (e.g., SIB2 relaxed measurement parameters) in a message (e.g., SIB2 related message, RRC Reconfiguration or any such messages). The one or more relaxed measurement parameters comprise at least one of a low mobility parameter or a cell edge parameter, the low mobility parameter indicates the mobility state (e.g., low mobility state, high mobility state, etc.) of the UE, and the cell edge parameter indicates the location of the UE with respect to the cell edge of the serving cell based on a signal strength of the UE.

In one or more embodiments of the disclosure, the processor 1120 is configured to receive, from the network, a configuration of a predefined timer (e.g., inactivity timer, HPLMN timer, DRX-inactivity timer, etc.), present in the USIM of the UE 1100, to perform the BPLMN search (e.g., HPLMN search, HPPLMN search, etc.). The processor 1120 is further configured to determine at least one of the mobility state or the location of the UE 1100 with respect to the edge of the serving cell of the VPLMN of the network based on the one or more relaxed measurement parameters.

In one or more embodiments of the disclosure, the processor 1120 is configured to defer the BPLMN search upon determining at least one of the UE 1100 being in the low mobility state or not being at the edge of the serving cell to optimize the power in the UE 1100, as described in conjunction with FIGS. 5A, 5B, 6A, and 6B.

In one or more embodiments of the disclosure, the processor 1120 is configured to update the predefined timer to perform the BPLMN search to increase the time gap (e.g., “x” minutes) to perform the BPLMN search, as described in conjunction with FIGS. 7A, 7B, 8A, and 8B. The processor 1120 is further configured to determine a lapse of the updated predefined timer. The processor 1120 is further configured to determine at least one of the mobility state or the location of the UE 1100 within the serving cell of the VPLMN based on the one or more relaxed measurement parameters. The processor 1120 is further configured to perform the BPLMN search upon determining at least one of the UE 1100 being in the high mobility state or located at the edge of the serving cell.

In one or more embodiments of the disclosure, the processor 1120 is configured to defer the near cell measurement search during the measurement gap of the CDRX sleep duration of the CDRX state to optimize the power in the UE 1100 upon determining at least one of the UE 1100 being in the low mobility state or not being located at the edge of the serving cell, as described in conjunction with FIGS. 9 and 10.

Although FIG. 11 shows various hardware components of the UE 1100, but it is to be understood that other embodiments are not limited thereon. In other embodiments of the disclosure, the UE 1100 may include less or more number of components. Further, the labels or names of the components are used only for illustrative purposes and do not limit the scope of the disclosure. One or more components can be combined to perform the same or substantially similar functions to optimize the power in the UE 1100.

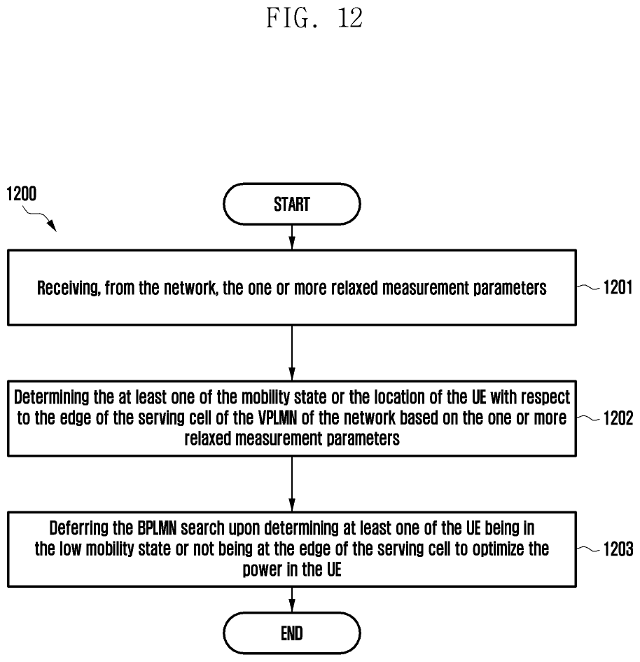

FIG. 12 is a flow diagram illustrating a method for HPLMN scanning when a UE is camped on a VPLMN of cellular network according to an embodiment of the disclosure.

Referring to FIG. 12, one or more steps of a method 1200 relate to one or more steps of the FIGS. 5A, 5B, 7A, and 7B.

At operation 1201, the method 1200 includes receiving, from the network, the one or more relaxed measurement parameters. The one or more relaxed measurement parameters comprises at least one of the low mobility parameter or the cell edge parameter, the low mobility parameter indicates the mobility state of the UE 1100, and the cell edge parameter indicates the location of the UE 1100 with respect to the cell edge of the serving cell based on the signal strength of the UE 1100.

At operation 1202, the method 1200 includes determining the at least one of the mobility state or the location of the UE 1100 with respect to the edge of the serving cell of the VPLMN of the network based on the one or more relaxed measurement parameters. The method 1200 further includes prior to determining the at least one of the mobility state or the location of the UE 1100 within the serving cell, receiving, from the network, the configuration of the predefined timer, present in the USIM of the UE 1100, to perform the BPLMN search.

At operation 1203, the method 1200 includes deferring the BPLMN search upon determining at least one of the UE 1100 being in the low mobility state or not being at the edge of the serving cell to optimize the power in the UE 1100. The method 1200 includes updating the predefined timer to perform the BPLMN search to increase the time gap to perform the BPLMN search.

In one embodiment of the disclosure, the method 1200 further includes determining the lapse of the updated predefined timer. In one embodiment of the disclosure, the method 1200 further includes determining at least one of the mobility state or the location of the UE 1100 within the serving cell of the VPLMN based on the one or more relaxed measurement parameters. In one embodiment of the disclosure, the method 1200 further includes performing the BPLMN search upon determining at least one of the UE 1100 being in the high mobility state or located at the edge of the serving cell.

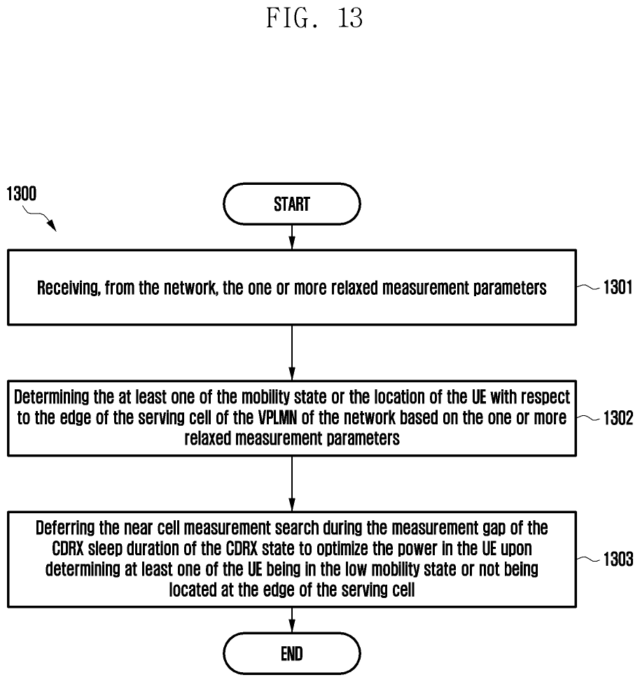

FIG. 13 is a flow diagram illustrating a method for performing neighbour cell measurements with overlapping measurement gap(s) and CDRX sleep duration according to an embodiment of the disclosure.

Referring to FIG. 13, one or more steps of a method 1300 relate to one or more steps of the FIG. 9.

At operation 1301, the method 1300 includes receiving, from the network, the one or more relaxed measurement parameters. The one or more relaxed measurement parameters comprises at least one of the low mobility parameter or the cell edge parameter, the low mobility parameter indicates the mobility state of the UE 1100, and the cell edge parameter indicates the location of the UE 1100 with respect to the cell edge of the serving cell based on the signal strength of the UE 1100.

At operation 1302, the method 1300 includes determining the at least one of the mobility state or the location of the UE 1100 with respect to the edge of the serving cell of the VPLMN of the network based on the one or more relaxed measurement parameters.

At operation 1303, the method 1300 includes deferring the near cell measurement search during the measurement gap of the CDRX sleep duration of the CDRX state to optimize the power consumption in the UE 1100 upon determining at least one of the UE 1100 being in the low mobility state or not being located at the edge of the serving cell.

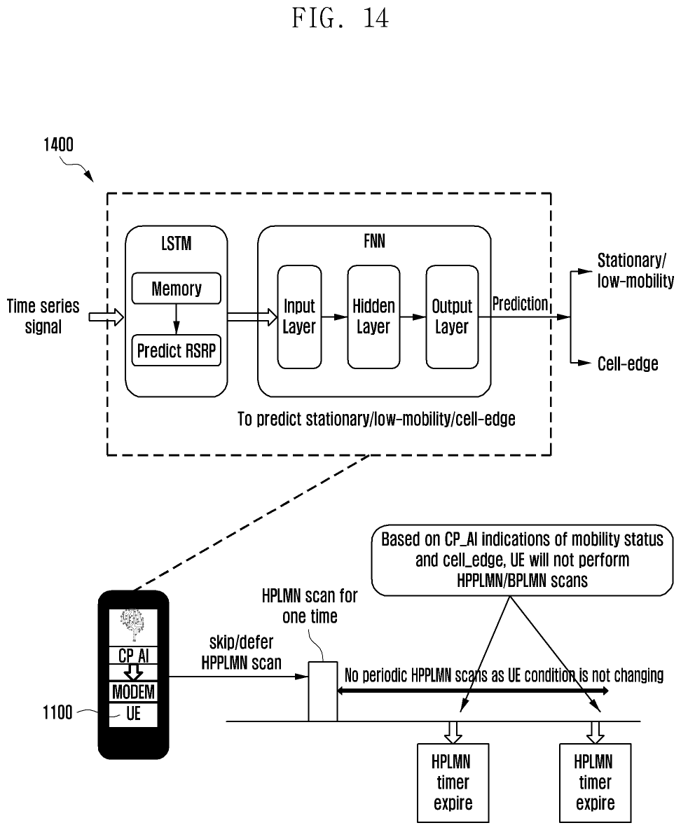

FIG. 14 illustrates various functionalities of an artificial intelligence (AI)/machine learning (ML) model 1400 associated with a UE for performing a higher priority scan optimization according to an embodiment of the disclosure.

Referring to FIG. 14, the AI/ML model may comprise a long short-term memory (LSTM) module and a feed-forward neural network (FNN) module. The LSTM module and the FNN module are configured to predict the state of the UE 1100 (e.g., stationary/low-mobility/cell-edge) within the cellular network. The LSTM module continuously receives a time series signal, where the time series signal is serving cell signal measurements (e.g., RSRP). Further, the LSTM module comprises two sub-modules, such as a memory module (i.e., the memory 1110) and an RSRP module. The memory module is configured to retain and manage information over time, while the RSRP module is configured to measure and analyze the reference signal received power (RSRP) of the UE 1100. The FNN module comprises one or more layers to predict the status of the UE (e.g., stationery/low-mobility/cell-edge). The one or more layers comprise an input layer, a hidden layer, and an output layer. These layers are configured to work together to process an input data (e.g., time series signal), apply transformations, and generate the desired output, which represents the predicted status of the UE 1100.

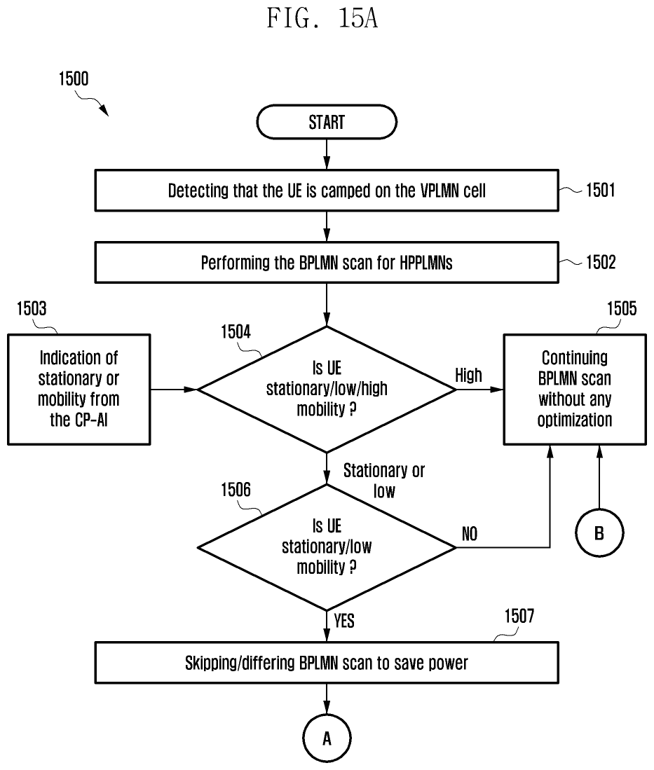

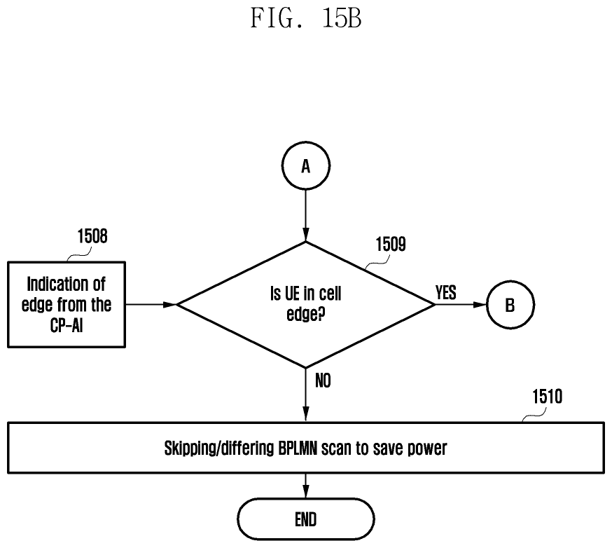

In one scenario, the UE 1100 is in the roaming area and camped to the VPLMN. Communication Processor (CP) AI module of the UE 1100 may indicate the mobility and cell edge condition to a modem of the UE 1100, based on which the UE 1100 may skip or defer the HPPLMN scan to save power. Based on the AI/ML prediction of the mobility and the cell-edge status, the modem may skip or defer the HPPLMN scans; the same methodology is explained in the FIGS. 15A and 15B. Similarly, the modem may apply the prediction of the mobility and the cell-edge status and skip the RRM measurements during the CDRX sleep duration.

A function associated with the various components of the UE 1100 may be performed through the non-volatile memory, the volatile memory, and the processor 1120. One or a plurality of processors controls the processing of the input data in accordance with a predefined operating rule or AI model stored in the non-volatile memory and the volatile memory. The predefined operating rule or AI model is provided through training or learning. Here, being provided through learning means that, by applying a learning mechanism to a plurality of learning data, a predefined operating rule or AI model of the desired characteristic is made. The learning may be performed in a device itself in which AI according to an embodiment is performed, and/or may be implemented through a separate server/system. The learning mechanism is a method for training a predetermined target device (for example, a robot) using a plurality of learning data to cause, allow, or control the target device to decide or predict. Examples of learning mechanisms include, but are not limited to, supervised learning, unsupervised learning, semi-supervised learning, or reinforcement learning.

The AI model may consist of a plurality of neural network layers. Each layer has a plurality of weight values and performs a layer operation through a calculation of a previous layer and an operation of a plurality of weights. Examples of neural networks include, but are not limited to, convolutional neural network (CNN), deep neural network (DNN), recurrent neural network (RNN), restricted Boltzmann machine (RBM), deep belief network (DBN), bidirectional recurrent deep neural network (BRDNN), generative adversarial networks (GAN), and deep Q-networks.

FIGS. 15A and 15B are flow diagrams illustrating a method for performing a higher priority scan optimization according to various embodiments of the disclosure.

Referring to FIGS. 15A and 15B, at operation 1501, a method 1500 includes detecting that the UE 1100 is camped on the VPLMN cell. At operation 1502, the method 1500 includes performing, by the UE 1100, the BPLMN scan for HPPLMNs. At operations 1503-1504, the method 1500 includes determining whether the UE 1100 is in the stationary state or low mobility state, or high mobility state based on an indication of the stationary state or mobility state from the CP-AI.

At operation 1505, the method 1500 includes continuing the BPLMN scan without any optimization in response to determining that the UE 1100 is in the high mobility state. At operation 1506, the method 1500 includes determining whether the UE 1100 is in the stationary state or low mobility state in response to determining that the UE 1100 is not in the high mobility state. At operation 1507, the method 1500 includes skipping or differing the BPLMN scan to save the power of the UE 1100. At operations 1508-1509, the method 1500 includes determining whether the UE 1100 is in the cell edge based on the indication of the cell edge from the CP-AI. The method 1500 includes continuing the BPLMN scan without any optimization in response to determining that the UE 1100 is in the cell edge. At operation 1510, the method 1500 includes skipping or differing the BPLMN scan to save the power of the UE 1100.

The various actions, acts, blocks, steps, or the like in the flow diagrams may be performed in the order presented, in a different order, or simultaneously. Further, in some embodiments of the disclosure, some of the actions, acts, blocks, steps, or the like may be omitted, added, modified, skipped, or the like without departing from the scope of the disclosure.

Unless otherwise defined, all technical and scientific terms used herein have the same meaning as commonly understood by one ordinary skilled in the art to which this disclosure belongs. The device, methods, and examples provided herein are illustrative only and not intended to be limiting.

While specific language has been used to describe the present subject matter, any limitations arising on account thereto, are not intended. As would be apparent to a person in the art, various working modifications may be made to the method to implement the inventive concept as taught herein. The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment.

The embodiments disclosed herein can be implemented using at least one hardware device and performing network management functions to control the elements.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore,

while the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) in a communication system, the method comprising:
receiving, from a network, a message including one or more relaxed measurement parameters;
determining at least one of a mobility state or a location of the UE with respect to an edge of a serving cell based on the one or more relaxed measurement parameters; and
deferring a background PLMN (BPLMN) search based on determining at least one of the UE being in a low mobility state or not being at the edge of the serving cell to optimize a power consumption in the UE.

2. The method of claim 1,
wherein the one or more relaxed measurement parameters comprise at least one of a low mobility parameter or a cell edge parameter,
wherein the low mobility parameter indicates the mobility state of the UE, and
wherein the cell edge parameter indicates the location of the UE with respect to the edge of the serving cell based on a signal strength of the UE.

3. The method of claim 1, further comprising:
prior to the determining of the at least one of the mobility state or the location of the UE within the serving cell, receiving, from the network, a configuration of a predefined timer, present in a universal subscriber identity module (USIM) of the UE, to perform the BPLMN search.

4. The method of claim 3, wherein the deferring of the BPLMN search comprises:
updating the predefined timer to perform a background PLMN (BPLMN) search to increase a time gap to perform the BPLMN search.

5. The method of claim 4, further comprising:
determining a lapse of the predefined timer;
determining at least one of the mobility state or the location of the UE within the serving cell based on the one or more relaxed measurement parameters; and
performing the BPLMN search upon determining at least one of the UE being in a high mobility state or located at the edge of the serving cell.

6. The method claim 1, wherein the BPLMN search comprises at least one of a home PLMN (HPLMN) search or a high priority PLMN (HPPLMN) search.

7. The method of claim 1, further comprising:
receiving one or more indications from at least one machine learning (ML) model, wherein the at least one ML model determines one or more states of the UE based on the one or more relaxed measurement parameters, and one or more states of the UE comprises at least one of a stationary state, a low mobility state, a high mobility state and a location state; and
performing one of:
continuing the BPLMN search when the one or more states of the UE comprises the at least one of the low mobility state and the high mobility state, wherein the location state indicates that the UE being at the edge of the serving cell, or
deferring the BPLMN search when the one or more states of the UE comprise the stationary state, wherein the location state indicates that the UE not being at the edge of the serving cell.

8. A method performed by a user equipment (UE) in a communication system, the method comprising:
receiving, from a network, a message including one or more relaxed measurement parameters;
determining at least one of a mobility state or a location of the UE with respect to an edge of a serving cell of the network based on the one or more relaxed measurement parameters; and
deferring a near cell measurement search during a measurement gap of a connected mode discontinuous reception (CDRX) sleep duration of a CDRX state to optimize a power consumption in the UE based on determining at least one of the UE being in a low mobility state or not being located at the edge of the serving cell.

9. The method of claim 8,
wherein the one or more relaxed measurement parameters comprise at least one of a low mobility parameter or a cell edge parameter,
wherein the low mobility parameter indicates the mobility state of the UE, and
wherein the cell edge parameter indicates the location of the UE with respect to the edge of the serving cell based on a signal strength of the UE.

10. The method of claim 8, further comprising:
receiving one or more indications from at least one machine learning (ML) model, wherein the at least one ML model determines one or more states of the UE based on the one or more relaxed measurement parameters, and one or more states of the UE comprises at least one of a stationary state, a low mobility state, a high mobility state and a location state; and
performing one of:
continuing the near cell measurement search during the measurement gap of the CDRX sleep duration of the CDRX state when the one or more states of the UE comprise the at least one of the low mobility state and the high mobility state, wherein the location state indicates that the UE being at the edge of the serving cell, or
deferring the near cell measurement search during the measurement gap of the CDRX sleep duration of the CDRX state to optimize the power consumption in the UE when the one or more states of the UE comprise the stationary state, wherein the location state indicates that the UE not being at the edge of the serving cell.

11. A communication device comprising:
a transceiver; and
a processor operably coupled with the transceiver and configured to:
receive, from a network, a message including one or more relaxed measurement parameters,
determine at least one of a mobility state or a location of a user equipment (UE) with respect to an edge of a serving cell based on the one or more relaxed measurement parameters, and
defer a background PLMN (BPLMN) search based on determining at least one of the UE being in a low mobility state or not being at the edge of the serving cell to optimize the power consumption in the UE.

12. The communication device of claim 11, wherein the processor is further configured to:
prior to determining the at least one of the mobility state or the location of the UE within the serving cell, receiving, from the network, a configuration of a predefined timer, present in a universal subscriber identity module (USIM) of the UE, to perform the BPLMN search.

13. The communication device of claim 12, wherein, in deferring the BPLMN search, the processor is further configured to:
update the predefined timer to perform a background PLMN (BPLMN) search to increase a time gap to perform the BPLMN search.

14. The communication device of claim 13, wherein the processor is further configured to:
determine a lapse of the predefined timer,
determine at least one of the mobility state or the location of the UE within the serving cell based on the one or more relaxed measurement parameters, and
perform the BPLMN search upon determining at least one of the UE being in a high mobility state or located at the edge of the serving cell.

15. The communication device of claim 11, wherein the processor is further configured to:
receive one or more indications from at least one machine learning (ML) model, wherein the at least one ML model determines one or more states of the UE based on the one or more relaxed measurement parameters, and one or more states of the UE comprises at least one of a stationary state, a low mobility state, a high mobility state and a location state, and
perform one of:
continuing the BPLMN search when the one or more states of the UE comprises the at least one of the low mobility state and the high mobility state, wherein the location state indicates that the UE being at the edge of the serving cell, or
deferring the BPLMN search when the one or more states of the UE comprise the stationary state, wherein the location state indicates that the UE not being at the edge of the serving cell.

16. The communication device of claim 11,
wherein the one or more relaxed measurement parameters comprise at least one of a low mobility parameter or a cell edge parameter,
wherein the low mobility parameter indicates the mobility state of the UE, and
wherein the cell edge parameter indicates the location of the UE with respect to the edge of the serving cell based on a signal strength of the UE.

17. The communication device of claim 11, wherein the BPLMN search comprises at least one of a home PLMN (HPLMN) search or a high priority PLMN (HPPLMN) search.

18. A communication device comprising:
a transceiver; and
a processor operably coupled with the transceiver and configured to:
receive, from a network, a message including one or more relaxed measurement parameters,
determine at least one of a mobility state or a location of a user equipment (UE) with respect to an edge of a serving cell of the network based on the one or more relaxed measurement parameters, and
defer a near cell measurement search during a measurement gap of a connected mode discontinuous reception (CDRX) sleep duration of a CDRX state to optimize a power in the UE based on determining at least one of the UE being in a low mobility state or not being located at the edge of the serving cell.

19. The communication device of claim 18, wherein the processor is further configured to:
receive one or more indications from at least one machine learning (ML) model, wherein the at least one ML model determines one or more states of the UE based on the one or more relaxed measurement parameters, and one or more states of the UE comprises at least one of a stationary state, a low mobility state, a high mobility state and a location state, and
perform one of:
continuing the near cell measurement search during the measurement gap of the CDRX sleep duration of the CDRX state when the one or more states of the UE comprise the at least one of the low mobility state and the high mobility state, wherein the location state indicates that the UE being at the edge of the serving cell, or
deferring the near cell measurement search during the measurement gap of the CDRX sleep duration of the CDRX state to optimize the power consumption in the UE when the one or more states of the UE comprise the stationary state, wherein the location state indicates that the UE not being at the edge of the serving cell.

20. The communication device of claim 18,
wherein the one or more relaxed measurement parameters comprise at least one of a low mobility parameter or a cell edge parameter,
wherein the low mobility parameter indicates the mobility state of the UE, and
wherein the cell edge parameter indicates the location of the UE with respect to the edge of the serving cell based on a signal strength of the UE.
